(19) United States
(12) Patent Application Publication
(10) Pub. No.: US 2012/0080574 A1
(43) Pub. Date: Apr. 5, 2012

(54) Method and apparatus of attaching a stringer between a pair of posts

(76) Inventor: Scott J. Mills, Kissimmee, FL (US)

(21) Appl. No.: 12/924,695

(22) Filed: Oct. 4, 2010

(51) Int. Cl. F16B 2/02; B23P 11/00; B25B 11/00

(52) U.S. Cl. 248/226.11; 29/464; 29/525.01

(57) ABSTRACT

A method and apparatus for attaching a stringer between a pair of posts includes a removably attachable bracket for supporting and aligning one end of a stringer between a pair of posts. The alignment bracket attaches to a post with compression clamping arms which are easily repositioned to adjust one end of the stringer. The method of attaching a stringer between a pair of posts uses a pair of stringer alignment brackets clamped onto two spaced posts for supporting a stringer between the posts. The stringer is leveled by repositioning the stringer alignment bracket at one end. One person can easily and rapidly attach the stringers between posts in the construction of a fence or deck.

### BACKGROUND OF THE INVENTION

The present invention relates to a method and apparatus for constructing a fence stringer, deck rail or the like and especially to a method and apparatus in which one person can align a stringer between posts for a fence or deck during construction of a fence or rail.

It is necessary to attach horizontal stringers or rails to vertical posts which are generally widely spaced apart. These stringers have to be leveled before they are attached to the posts and this generally requires two people to hold the stringer in place while the stringer is being leveled. The stringer can be attached to the post with an attaching bracket or by nailing each end of the stringer to the post. Normally, one person holds one end of a stringer in position on one post while a second person holds the other end of the stringer. A bubble level is used to level the stringer between the posts. The stringer is moved by hand until level at which time each end of the stringer can be attached to their respective posts. This requires two people and makes it inconvenient and difficult for a single person to build a fence or railing without the help of a second person.

The present invention is directed towards a method and apparatus for one person to attach and level a stringer or rail between a pair of posts in the building of a fence, deck or the like.

In the past, it has been common to provide brackets for attaching stringers or rails between upright posts. Generally, this involves attaching a metal bracket to a fence or deck post and then attaching each end of a stringer to the bracket. These brackets are generally attached to the post with screws or nails and the end of a fence stringer placed therein and attached thereto with a nail or threaded fastener. This type of stringer-to-post bracket can be seen in the DeSouza U.S. Pat. No. 6,290,214 for a Rail Fence Bracket and in the Morris U.S. Pat. No. 4,616,950 for a Timber Joining Device. The Spruill U.S. Pat. No. 6,543,751 is for a Rail and Fence Bracket Apparatus while the Preta U.S. Pat. No. 6,802,496 is for a Fence Bracket System and Fence System Using the Fence Bracket System. The Erwin U.S. Pat. No. 6,471,192 shows a Rail-to-Post Mounting Bracket while the Platt U.S. Pat. No. 5,788,224 is for a Fence Rail Clip. The West U.S. Pat. No. 5,873,671 is for a Rail Attachment Bracket with a Snap-on Cover while the Dye U.S. Pat. No. 5,544,866 is for a handrail assembly for the installation of a wooden handrail between two upright supporting posts. The two Platt U.S. Pat. No. 7,125,002 and U.S. Pat. No. 7,216,855 are each for a fence rail mounting clip for connecting a hollow fence rail to a vertical post.

In the Lewis U.S. Pat. No. 5,673,903 an Apparatus for Temporarily Supporting One End of a Cross Piece during the Construction of a Deck or Fence Rail is disclosed. In this bracket, a C-shaped frame is similar to a C-clamp and has a threaded portion for driving the clamp against one side of the fence post while the other side supports a crosspiece member which is supported on a ledge or which may be clamped to the post. This clamping member is used to enable a person to attached crosspieces to adjacent posts during the construction of deck rails and fences by supporting one end of a rail with the other end being positioned and attached to a spaced post.

The present invention teaches a method for one person to attach a fence stringer or deck rail between a pair of posts and supports the fence stringer between two posts while leveling the stringer. The leveled stringer can then be attached to each post. The present bracket aligns the stringer in the middle of a post rather than merely attaching the stringer to a side of a post. The present bracket allows for the positioning of a conventional stringer-to-post attaching bracket to be held in the present bracket during or after alignment of the fence stringer for attaching the stringer-to-post bracket to a post. After the stringer-to-post bracket is attached to a post, the fence stringer is inserted thereinto and attached to the stringer-to-post bracket.

The present bracket is supported with a compression clamp which allows the bracket to be easily repositioned up and down on the post to level the stringer between the posts before attaching the stringer to the posts.

### SUMMARY OF THE INVENTION

A bracket for supporting and aligning one end of a stringer between a pair of posts, such as fence or railing post. A stringer alignment bracket has a compression clamp having a pair of clamping arms spaced for removably clamping onto the side of a post. The bracket has a stringer end supporting platform located between the bracket pair of clamping arms and a pair of spaced centering members, which spaced centering members are located above and to each side of the platform for positioning one end of a stringer therebetween. The alignment bracket can be removably attached to a fence or railing post to support one end of the stringer while aligning and attaching the stringer between a pair of posts. The clamping arms have a curved or angled edge for pushing onto and clamping to a fence post.

The method of attaching a stringer between a pair of fence or railing posts includes selecting a bracket for supporting and aligning one end of a stringer on a post and removably clamping the first of the selected alignment brackets to a post and placing one end of a stringer in the selected alignment bracket removably attached to a post. A second alignment bracket is removably clamped to a second fence post and the other end of the stringer placed in the second alignment bracket to thereby support the stringer between two posts. One selected alignment bracket can be moved on one of said posts to position and level a stringer between the posts so that the stringer can be rapidly attached between posts when building a fence or deck. The method includes placing a level on the stringer supported between two posts and leveling the stringer between the posts. Each end of the stringer can then be nailed to a post. Alternatively, a stringer-to-post bracket can be placed in each alignment bracket prior to placing the end of a stringer therein and the stringer then removed while the stringer-to-post bracket is attached to the post. The end of the stringer can then be attached to the stringer-to-post bracket. Each alignment bracket has a pair of angled or curved removable compression clamps for clamping onto a post and each clamping arm has a plurality of crimping striations thereon for gripping the arms. The alignment bracket can be made of a one-piece polymer material.

### BRIEF DESCRIPTION OF THE DRAWINGS

Other objects, features, and advantages of the present invention will be apparent from the written description and the drawings in which:

FIG. 1 is a perspective view of a fence under construction using the present method and apparatus for attaching a pair of fence stringers between a pair of posts;

FIG. 2 is an exploded perspective view of a section of a fence post having the present alignment bracket being removably attached thereto and having a fence stringer-to-post bracket being positioned for attaching to the post;

FIG. 3 is a partial perspective view of the bracket of the present invention removably attached to a post with a stringer-to-post bracket positioned thereon;

FIG. 4 is a partial perspective view of the post of FIG. 3 showing the end of a stringer inserted into a stringer-to-post attaching bracket;

FIG. 5 is a partial perspective view of the end of a fence stringer attached to a post;

FIG. 6 is an exploded perspective showing an alternate embodiment of a method of aligning and attaching a fence stringer to a post using the alignment bracket of the present invention in which the bracket is positioned on a post and supporting a fence stringer therein; and

FIG. 7 is a partial perspective view of a fence stringer supported in the bracket alignment of the present invention and being nailed to the fence post.

### DETAILED DESCRIPTION OF THE PREFERRED EMBODIMENT

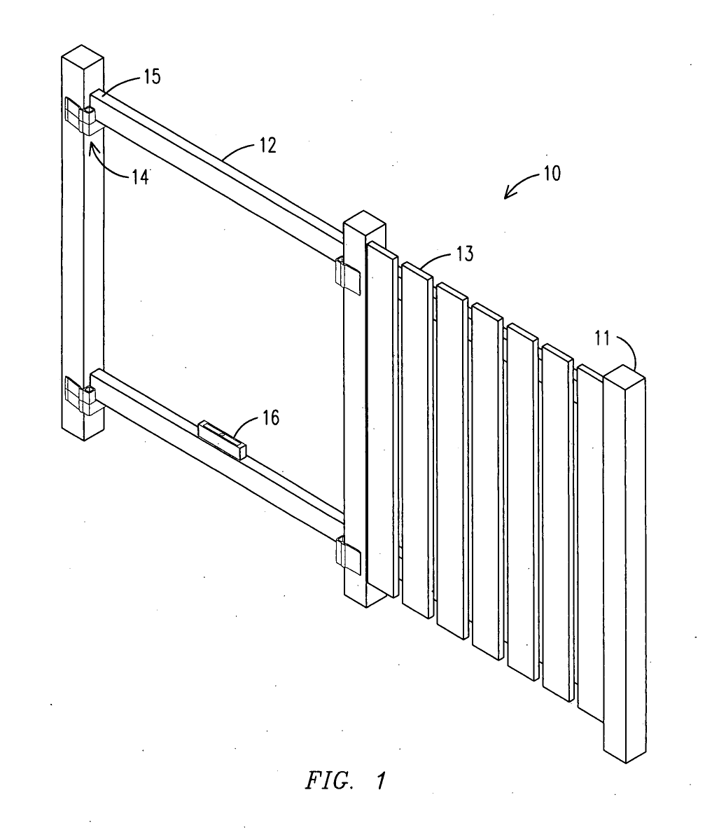

Referring to FIG. 1, a fence 10 is under construction and has a plurality of spaced fence posts 11 and a pair of fence stringers 12 between each pair of posts. A plurality of boards 13 are attached to the stringers 12. The boards 13 can also be slats or pickets and can be made of a solid plywood or other materials as desired. In addition, if the boards 13 are not used, the stringers 12 become rails. The stringers in FIG. 1 can be seen supported by a fence stringer alignment bracket 14 at each end. An alignment bracket supports each end 15 of a stringer 12. A level 16 is shown on top of one of the stringers 12 for leveling the stringer before it is attached to the post 11.

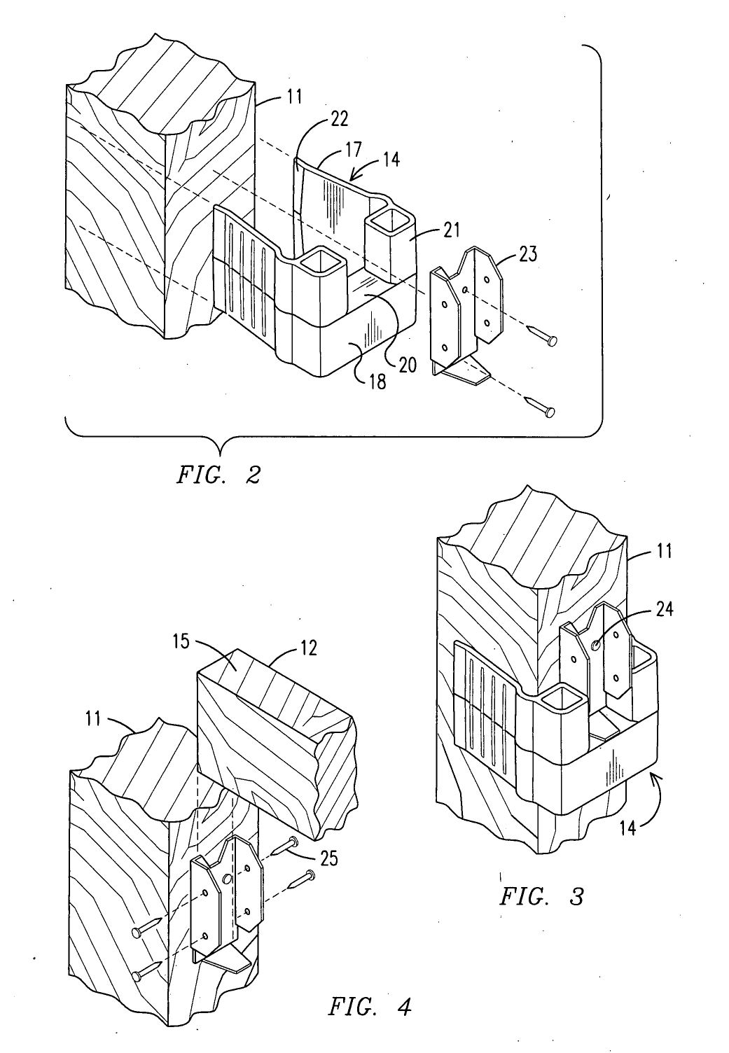

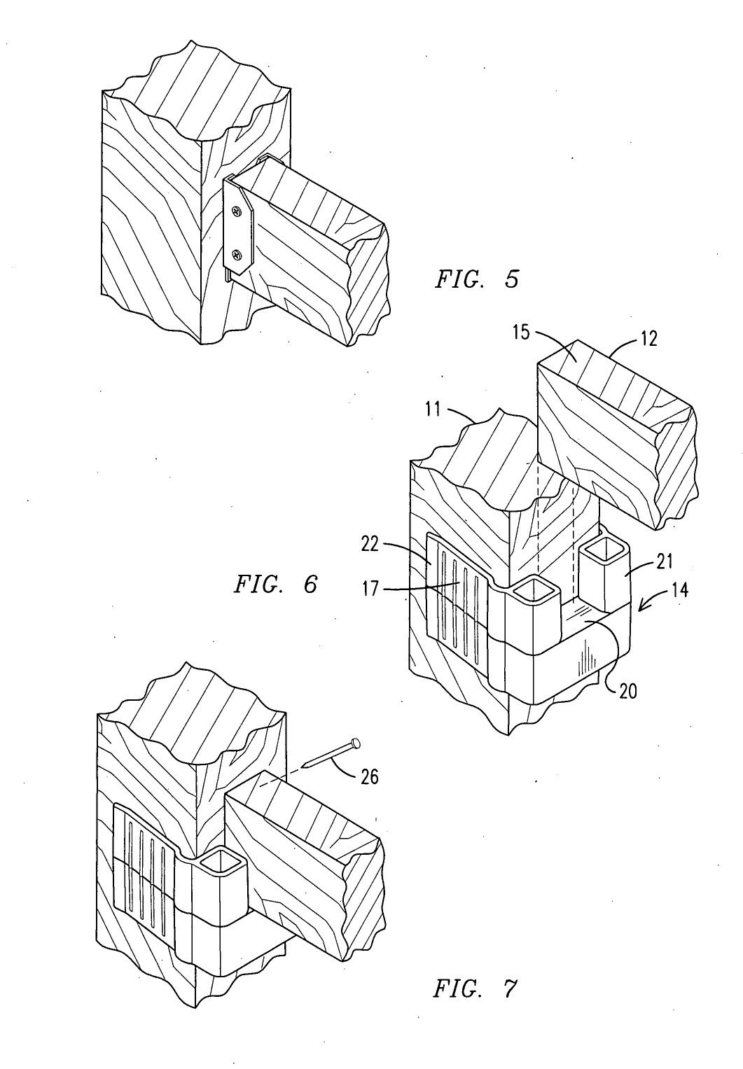

Referring to FIGS. 1 through 5, the bracket 14 can be seen having a compression clamp along with a pair of clamp arms 17. The clamp arms of the bracket 14 are attached to a base 18 which forms a supporting platform 20 having a pair of side centering members 21 sized to support a stringer end 15 on the platform 20. The clamp arms 17 each have an angled or curved edge 22 and are spaced to be slid onto a post 11 while expanding the arms 17 to clamp the stringer alignment bracket 14 onto the post 11. The stringer end 15 can be placed directly on the platform 20 between the sides 21 once the clamp 14 has been clamped onto the post 11. However, in FIGS. 2 through 5, a stringer-to-post bracket 23 is held on the platform 20 between the sides 21 and against the post, as shown in FIG. 3. The alignment bracket 14 holds the stringer-to-post bracket against the post where it is nailed with a plurality of nails 24. Other fasteners, such as screws, can also be used to fasten the stringer-to-post bracket to the post. The stringer-to-post bracket 23 is positioned and attached after a stringer has been placed between the posts 11 in a pair of stringer alignment brackets 14 and after the stringers 12 have been leveled with a level 16. Once the stringer-to-post bracket 23 has been attached to the post 11, the stringer 12, end 15 can be inserted thereinto, as shown in FIG. 4, and attached with nails 25 through the side openings in the stringer-to-post bracket 23. The stringer 12 is attached between a pair of posts.

The stringer alignment bracket 14 advantageously allows a fence to be built by one person using the rapidly attached and removable stringer alignment brackets 14. One person can individually align and level a stringer between posts without having to have a second person hold one end while making markings or adjustments. This allows for an accurate leveling of stringers by the easy movement of the clamping brackets 14 which are easily and quickly attached to posts and then easily repositioned, as desired. Once the stringers are attached, the boards 13 or other siding can be attached to the stringers or the stringers can be attached as rails. It will be clear that the stringer alignment bracket 14 can be used on 4×4 posts 11 as well as 6×6 or any other size posts desired and can be easily injection molded of a one-piece polymer material.

Referring to FIGS. 6 and 7, a similar process for attaching stringers 12 to a post 11 while constructing a fence or deck or the like is illustrated having the alignment bracket 14 clamped to a post 11 and a stringer 12, end 15 inserted thereinto between the side guides 21 of the alignment bracket 14. The alignment bracket 14 is clamped onto a post 11 with the clamping arms 17 which easily slide onto the post 11 guided by the angled edges 22 when the bracket 14 is pushed or shoved onto the post.

In FIG. 7, a stringer 12 has been inserted into a stringer alignment bracket 14 and is being attached by toe nailing with a nail 26. Once one end of the stringer has been attached to a post 11, the other end is attached in a similar manner to a spaced post.

It should be clear at this time that a bracket for supporting and aligning one end of a fence stringer has been provided which is utilized in a method of attaching stringers between pairs of posts. However, the present invention should not be construed as limited to the forms shown herein which are to be considered illustrative rather than restrictive.

I claim:

1. A method of attaching a stringer between a pair of posts including the steps of:
selecting a stringer alignment bracket having a compression clamp having a pair of clamp arms spaced for removably clamping said alignment bracket onto the side of a post, said alignment bracket having a stringer end supporting platform located between said bracket pair of clamp arms and having a pair of spaced centering members, each spaced centering member being located above and on each side of said platform for positioning one end of a stringer therebetween:
removably clamping a first selected alignment bracket to a post;
placing one end of a stringer in said first selected alignment bracket;
removably clamping a second alignment bracket to a second post;
placing the other end of said stringer in said second alignment bracket to thereby support said stringer between two posts;
moving at least one said selected alignment bracket on one of said posts to position and level said stringer between said posts whereby a stinger can be rapidly attached between posts.

2. The method of attaching a stringer between a pair of posts in accordance with claim 1 including the step of placing a level on said stringer supported between two posts and leveling said stringer.

3. The method of attaching a stringer between a pair of posts in accordance with claim 2 including the step of nailing each end of said stringer supported between two posts to each post.

4. The method of attaching a stringer between a pair of posts in accordance with claim 2 including the step of placing a stringer-to-post mounting bracket in each said alignment bracket prior to placing the end of a stringer therein.

5. The method of attaching a stringer between a pair of posts in accordance with claim 4 including the step of removing said stringer and attaching said stringer-to-post bracket to one said post prior to removing said alignment bracket.

6. The method of attaching a stringer between a pair of posts in accordance with claim 5 including the step of placing each end of a stringer in each stringer-to-post mounting bracket on each post and attaching each stringer end thereto.

7. The method of attaching a stringer between a pair of posts in accordance with claim 6 in which the step of selecting a stringer alignment bracket includes selecting an alignment bracket having a pair of clamping arms, each being curved for removably compression clamping onto a post.

8. The method of attaching a stringer between a pair of posts in accordance with claim 7 in which the step of selecting a stringer alignment bracket includes selecting an alignment bracket having a pair of clamp arms, each clamping arm having a plurality of gripping striations for gripping said arm.

9. The method of attaching a stringer between a pair of posts in accordance with claim 8 in which the step of selecting a stringer alignment bracket includes selecting a stringer bracket formed of one piece of polymer material.

10. A bracket for supporting and aligning one end of a stringer comprising:
a stringer alignment bracket forming a compression clamp having a pair of clamping arms spaced for removably clamping onto the side of a post, said bracket having a stringer end supporting platform located between said bracket pair of clamping arms and said bracket having a pair of spaced centering members, each spaced centering member being located above and on each side of said platform for positioning one end of a stringer therebetween, whereby said alignment bracket can be removably attached to a post to support one end of a stringer while aligning and attaching said stringer between a pair of posts.

11. The bracket for supporting and aligning one end of a stringer in accordance with claim 10 in which said stringer alignment bracket is formed of one piece of polymer material.

12. The bracket for supporting and aligning one end of a stringer in accordance with claim 11 in which each said clamp arm is curved for pushing onto and clamping to a post.

13. The bracket for supporting and aligning one end of a stringer in accordance with claim 12 in which each said clamping arm has a plurality of gripping striations for gripping said arm.
